(19) United States
(12) Patent Application Publication
(10) Pub. No.: US 2018/0152740 A1
(43) Pub. Date: May 31, 2018

(54) CENTRALIZED METADATA RETRIEVAL

(71) Applicant: The DIRECTV Group, Inc., El Segundo, CA (US)

(72) Inventors: Sudheer Bandela, Torrance, CA (US); Tony Corkhill, La Palma, CA (US); Hai Kim Nguyen, Torrance, CA (US); Heather Nga Truong, Anaheim, CA (US)

(21) Appl. No.: 15/363,040

(22) Filed: Nov. 29, 2016

(51) Int. Cl. H04N 21/235; H04N 21/482; H04N 21/61; H04N 21/458

(52) U.S. Cl. CPC H04N 21/2353; H04N 21/482; H04N 21/4586; H04N 21/6193; H04N 21/6143

(57) ABSTRACT

Centralized metadata retrieval is presented herein. A method can include receiving, by a system comprising a processor, electronic program guide metadata from a network storage device of a data streaming service; storing, by the system, the electronic program guide metadata in a local storage device of the system; and in response to receiving a program guide based request from a satellite receiver device corresponding to the data streaming service, retrieving, by the system, a portion of the electronic program guide metadata corresponding to the program guide based request from the local storage device, and sending, by the system, the portion of the electronic program guide metadata directed to the satellite receiver device for facilitating a display, via the satellite receiver device, of content corresponding to the portion of the electronic program guide metadata.

### TECHNICAL FIELD

The subject disclosure generally relates to centralized metadata retrieval.

### BACKGROUND

Electronic program, or television, guides (EPGs) provide users of television services with scheduling information for current and upcoming programming. However, bandwidth, time, and/or set-top box (STB) storage constraints limit an amount of program information that can be accessed via an STB. Consequently, conventional STB technologies have had some drawbacks, some of which may be noted with reference to the various embodiments described herein below.

### BRIEF DESCRIPTION OF THE DRAWINGS

Non-limiting embodiments of the subject disclosure are described with reference to the following figures, wherein like reference numerals refer to like parts throughout the various views unless otherwise specified:

FIG. 1 illustrates a block diagram of a centralized metadata retrieval environment, in accordance with various example embodiments;

FIG. 2 illustrates a block diagram of a satellite-based STB environment, in accordance with various example embodiments;

FIG. 3 illustrates a block diagram of display content corresponding to centralized metadata, in accordance with various example embodiments;

FIG. 4 illustrates a block diagram of other display content corresponding to centralized metadata, in accordance with various example embodiments;

FIG. 5 illustrates a block diagram of an STB, in accordance with various example embodiments;

FIG. 6 illustrates a block diagram of a metadata server, in accordance with various example embodiments;

FIGS. 7-9 illustrate block diagrams of methods performed by a metadata server, in accordance with various example embodiments;

FIGS. 10-11 illustrate block diagrams of a method performed by an STB, in accordance with various example embodiments; and

FIG. 12 illustrates a block diagram representing an illustrative non-limiting computing system or operating environment in which one or more aspects of various embodiments described herein can be implemented.

### DETAILED DESCRIPTION

Aspects of the subject disclosure will now be described more fully hereinafter with reference to the accompanying drawings in which example embodiments are shown. In the following description, for purposes of explanation, numerous specific details are set forth in order to provide a thorough understanding of the various embodiments. However, the subject disclosure may be embodied in many different forms and should not be construed as limited to the example embodiments set forth herein.

As described above, conventional STB technologies have had some drawbacks with respect to providing program information via an STB in bandwidth, time, and/or STB storage constrained environments. Various embodiments disclosed herein can enable set-top boxes installed in such environments to display electronic program guide information, e.g., comprising posters of movies, detailed information about the movies, e.g., cast, crew, actor biographies, etc. utilizing a local, centralized metadata server installed at a location, business, hotel, etc. and coupled to set-top boxes at the location. In this regard, such centralized storage and access of electronic program guide information can preserve and/or reduce use of Internet and/or satellite based communication resources to communicate electronic program guide information to the set-top boxes. Further, the centralized storage of the electronic program guide information can enable the set-top boxes to display electronic program information using a limited, small, etc. amount of available memory, storage, etc.

For example, a method can comprise receiving, by a system comprising a processor, electronic program guide (EPG) metadata, advanced program guide (APG) metadata, etc. from a network storage device, e.g., a cloud based storage device of a group of distributed, e.g., co-located, located remotely from each other, etc. network storage devices of a data streaming service, e.g., a direct-broadcast satellite television service.

Further, the method can comprise storing, by the system, the EPG metadata in a local storage device of the system, e.g., a disk drive, a disk storage, etc. of a server, metadata server, etc. In embodiment(s), the EPG metadata can comprise information corresponding to content, e.g., movies, and such information can comprise poster(s), pictures, program information comprising a title of a movie, a rating of the move, a type of the movie, a time of broadcast of the movie, a cast of the movie, a producer/production crew of the movie, a director of the movie, biographies of actors of the movie, content, e.g., sequels, prequels, etc. related to the movie, etc.

In one embodiment, the electronic program guide metadata describes content, e.g., movies, of the data streaming service, e.g., direct-broadcast satellite television service, etc. that can be received via a broadcast directed from a satellite wirelessly coupled to a satellite receiver device, e.g., set-top box (STB).

In another embodiment, the EPG metadata corresponds to a movie data store, an Internet Movie Database (IMDb), etc. accessible via an Internet connection of the system, and the receiving of the EPG metadata from the network storage device can comprise receiving the EPG metadata via an Internet connection coupled between the system and the movie data store.

Further, in response to receiving, from the STB via a local area network (LAN) interface coupling the system to the STB, a program guide based request for the information corresponding to the content of the data streaming service, the method can comprise retrieving, by the system, a portion of the EPG metadata corresponding to the program guide based request from the local storage device, and sending, by the system, the portion of the EPG metadata to the STB for facilitating a display, via the STB, of content, e.g., movie poster(s), television show poster(s), etc. corresponding to the portion of the EPG metadata. In an embodiment, the sending of the portion of the EPG metadata can comprise sending the EPG metadata to the STB using the LAN.

In yet another embodiment, the method can further comprise determining, by the system, whether respective portions of the EPG metadata that have been stored in the network storage device and the local storage device are different. In this regard, in response to determining that the respective portions of the EPG metadata are different, the method can further comprise copying, by the system, a remote portion of the respective portions from the network storage device to a local portion of the respective portions of the EPG metadata on the local storage device.

Another embodiment can comprise a system, e.g., metadata server, comprising a processor and a memory that stores executable instructions that, when executed by the processor, facilitate performance of operations, comprising: obtaining metadata corresponding to a data, e.g., movie, television show, premium content, etc. streaming service from a network data store; storing the metadata in a data storage device of the system; and in response to receiving a request for a portion of the metadata from an STB of the data streaming service, sending the portion of the metadata to the STB to facilitate a display of content, e.g., poster(s), pictures, program information comprising a title of a movie, television show, premium content, etc.; a rating of the movie, television show, premium content, etc.; a type of the movie, television show, premium content, etc.; a time of broadcast of the movie, television show, premium content, etc.; a cast of the movie, television show, premium content, etc.; a producer/production crew of the movie, television show, premium content, etc.; a director of the movie, television show, premium content, etc.; biographies of actors of the movie, television show, premium content, etc.; sequels, prequels, related content, etc. of the movie, television show, premium content, etc.

In an embodiment, the obtaining of the metadata further comprises obtaining the metadata via an Internet based connection between the system and the network data store. In one embodiment, the metadata describes content of the data streaming service pending or being broadcast from a satellite to the STB. In another embodiment, the content comprises a direct-broadcast satellite television signal.

In yet another embodiment, the receiving of the request further comprises receiving the request for the portion of the metadata from the STB via a LAN interface between the system and the STB. Further, in an embodiment, the sending further comprises sending the portion of the metadata to the STB using the LAN interface.

In one embodiment, the operations can further comprise copying remotely stored metadata from the network data store to the data storage device of the system in response to determining that the remotely stored metadata of the network data store has changed in the network data store.

Another embodiment can comprise a machine-readable storage medium, comprising executable instructions that, when executed by a processor, facilitate performance of operations, comprising: in response to determining, via a wireless interface of a satellite receiver device, that a request for EPG metadata has been received, sending, by a satellite receiver device via a network device of a LAN, the request directed to a storage device; in response to the sending of the request, receiving, by the satellite receiver device via the network device of the LAN, the EPG metadata from the storage device; and displaying, by the satellite receiver device via a display device, content represented by the EPG metadata.

In an embodiment, the operations can further comprise receiving, by the satellite receiver device, a data stream from a satellite corresponding to the content represented by the EPG metadata.

In one embodiment, the receiving further comprises receiving the EPG metadata from the storage device, in which the storage device obtained the EPG metadata from a cloud based storage device corresponding to a data streaming service. In yet another embodiment, the data streaming service comprises a direct-broadcast satellite television service.

Reference throughout this specification to “one embodiment,” or “an embodiment,” means that a particular feature, structure, or characteristic described in connection with the embodiment is included in at least one embodiment. Thus, the appearances of the phrase “in one embodiment,” or “in an embodiment,” in various places throughout this specification are not necessarily all referring to the same embodiment. Furthermore, the particular features, structures, or characteristics may be combined in any suitable manner in one or more embodiments.

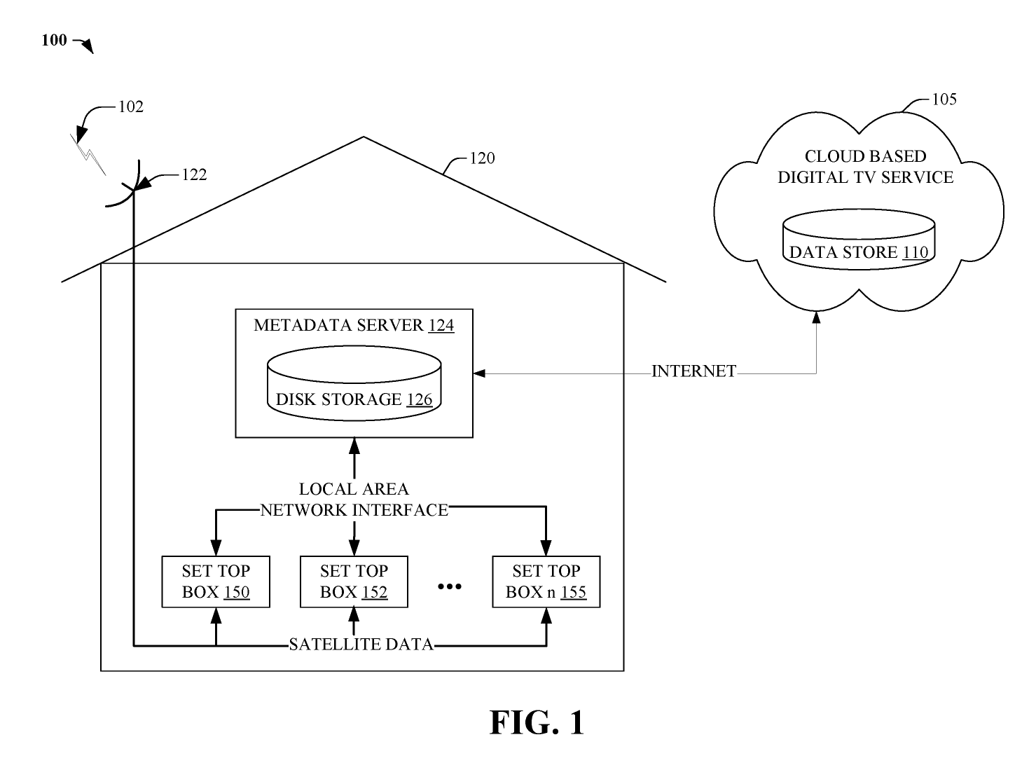

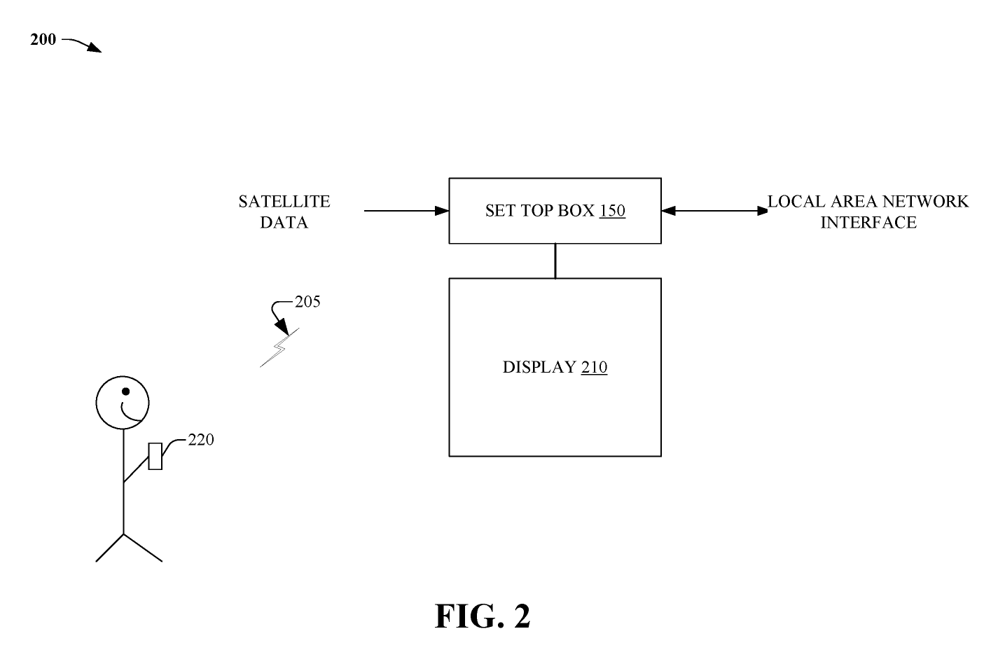

Referring now to FIG. 1, a block diagram of a centralized metadata retrieval environment (100) is illustrated, in accordance with various example embodiments. Location 120, e.g., a hotel, a business providing broadcast streaming services of, e.g., movies, television (TV) shows, music concerts, events, etc. to customers, etc. can comprise set top boxes (150, 152, 155) receiving, via satellite receiver 122, e.g., a satellite dish, satellite data representing wireless broadcasts 102 received from a satellite (not shown), e.g., comprising content of the broadcast streaming services, e.g., a direct-broadcast satellite television service. The satellite data can comprise a broadcast stream e.g., movie, television show, premium content, etc. provided to the customers on site, e.g., different rooms, portions, etc. of location 120 As illustrated by FIG. 2, each STB, e.g., 150, can be communicatively coupled to a display, e.g., 210, e.g., TV, display device, monitor, etc. for viewing the content of the broadcast streaming services. In this regard, the STB can be wirelessly coupled to a remote device, control, etc., e.g., 220, for receiving input from a user for controlling selection, viewing, etc. of the content.

Returning now to FIG. 1, to facilitate preservation and/or reduction of use of satellite and/or Internet based resources associated with direct communication of EPG metadata to set-top boxes, and/or to facilitate reception of a smaller portion of EPG metadata by set-top boxes having reduced memory and/or storage capabilities, metadata server 124 can centrally retrieve and store electronic program guide information corresponding to a broadcast stream, e.g., a movie, a TV show, premium content, etc. from a network storage device of a data streaming service, e.g., to facilitate local access of at least a portion of the electronic program guide information by the set-top boxes.

In this regard, metadata server 124 can receive, via the Internet, EPG metadata from data store 110, e.g., a movie data store, an Internet Movie Database (IMDb), etc. of cloud based digital TV service 105. In embodiment(s), content of the EPG metadata can comprise information comprises poster(s), pictures, program information comprising a title of a movie/TV show/premium content, a rating of the move/TV show/premium content, a type/genre of the movie/TV show/premium content, a time of broadcast of the movie/TV show/premium content, a cast of the movie/TV show/premium content, a producer/production crew of the movie/TV show/premium content, a director of the movie/TV show/premium content, biographies of actors of the movie/TV show/premium content, sequels/prequels/other content related to the movie/TV show/premium content, etc.

Further, metadata server 124 can locally store the EPG metadata in disk storage 126, e.g., an internal disk drive, an external disk drive, a non-volatile memory (e.g., flash memory), etc. In turn, metadata server 124 can receive, via a LAN interface coupling metadata server 124 to the set-top boxes, a program guide based request from an STB of the set-top boxes. In this regard, the program guide request can comprise a request for information about, describing, etc. a broadcast stream, e.g., a movie, a TV show, premium content, etc. As described above, such information can comprise poster(s), pictures, etc.

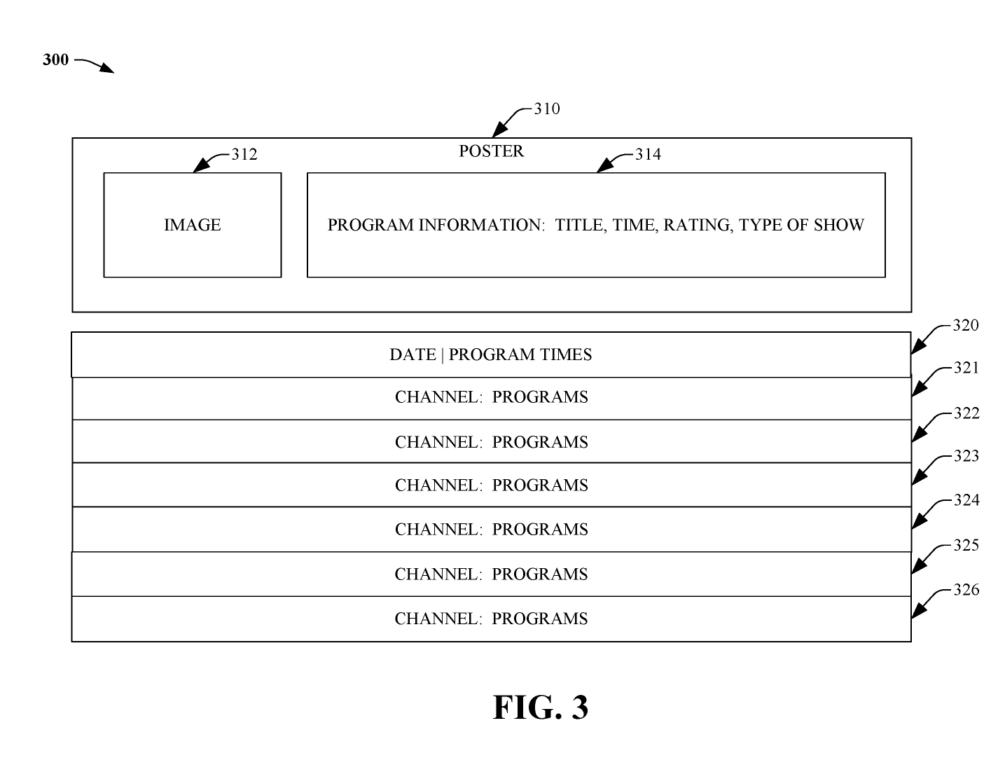

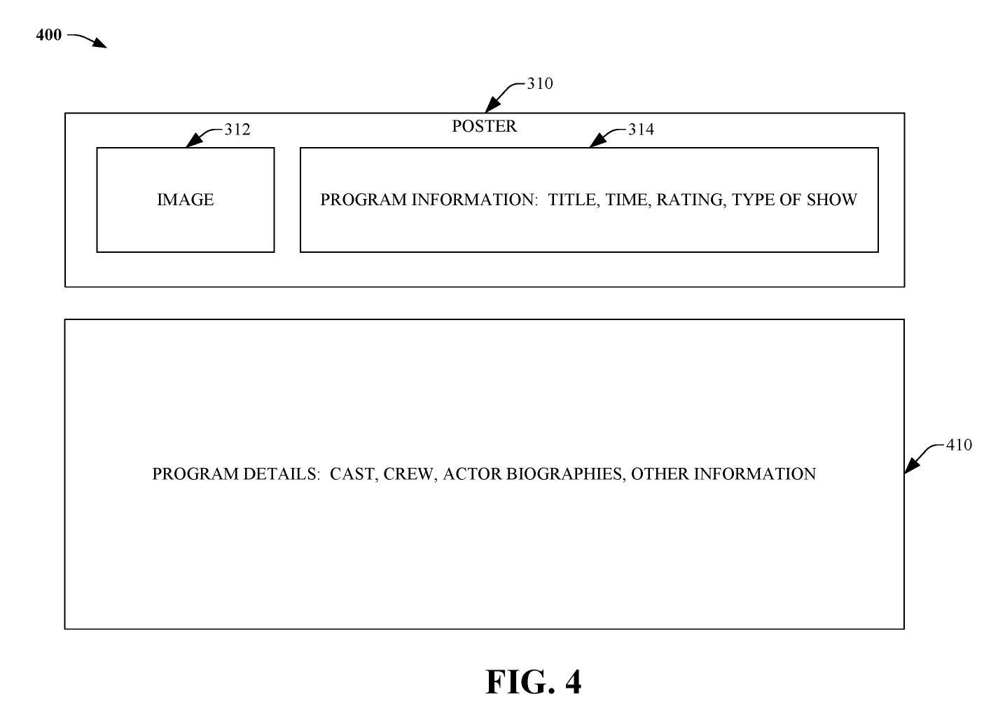

In turn, metadata server 124 can retrieve a portion of the EPG metadata comprising the information from disk storage 126, and send, via the LAN interface, the portion of the EPG metadata to the STB for facilitating a display, via display 210, of the information. As illustrated by FIG. 3, based on the EPG metadata, STB 150 can display, via display 210, poster 310 representing content of a broadcast stream pending or being broadcast from a satellite to satellite receiver 122. Poster 310 can comprise image 312, e.g., a picture, representing the broadcast stream and program information 314 describing content, e.g., a title of the content, a time of broadcast of the content, a rating of the content, a type of the content, etc.

Further, based on the EPG metadata, STB 150 can display, via display 210, date and program time header 320, and channels with corresponding programs (321-326) pending broadcast/being broadcast from the channels via satellite receiver 122 during program time(s) displayed in date and program time header 320.

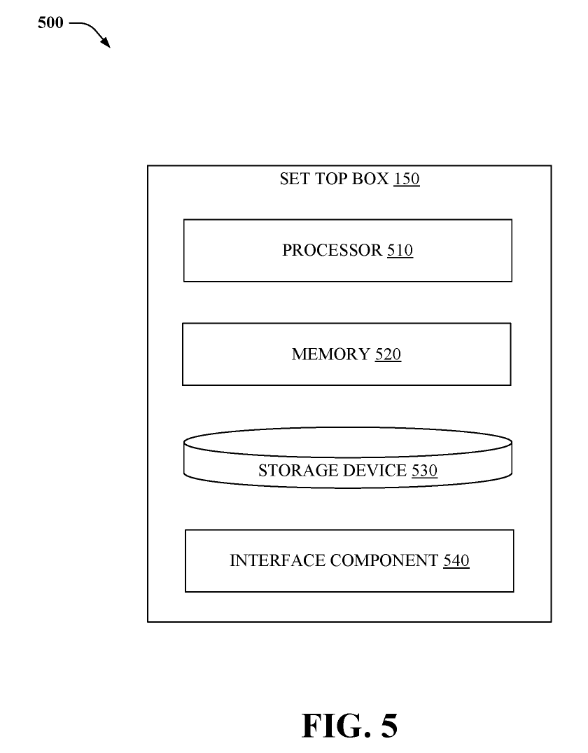

In another embodiment illustrated by FIG. 5, in addition to displaying, based on the EPG metadata via display 210, poster 310 comprising image 312 and program information 314 for content pending broadcast/being broadcast to STB 150 via satellite receiver 122, STB 150 can display program details 410 comprising a cast, crew (e.g., producer, production crew, etc.), actor biographies, and other information comprising, for example, sequels/prequels/other content related to content pending broadcast/being broadcast, etc.

In this regard, as illustrated by FIG. 5, STB 150 can comprise processor 510, memory 520, storage device 530, and interface component 540. Processor 510 can execute instructions stored in memory 520 to facilitate operations described herein that are performed by STB 150. For example, in various embodiment(s), interface component 540 can wirelessly couple, via wireless interface 205, STB 150 to remote device 220 in order to detect a request, input, etc. received from a user, e.g., for selecting, viewing, etc. a poster (e.g., 310), program details (e.g., 410), other information, etc. associated with and/or representing a defined broadcast stream that can be received from remote device 220.

Further, in response to detecting that the request, input, etc. for selecting, viewing, etc. the poster, program details, other information, etc. has been received, STB 150 can send, via a network device (not shown) of the LAN interface, the request to a storage device, storage system, server, etc. (e.g., meta data server 124). In turn, in response to the sending of the request to the storage device, STB 150 can receive, via the network device of the LAN, EPG metadata from the storage device comprising the poster, program details, other information, etc. associated with and/or representing the defined broadcast stream, and display, using the EPG metadata, the poster, program details, other information, etc. via display 210.

In embodiment(s), STB 150 can store the received EPG metadata in storage device 530, e.g., a hard drive, a flash drive, etc. In this regard, although storage device 530 is shown to be included in STB 150 as an internal storage device, drive, etc., storage device 530 can be an external storage device, drive, etc. Processor 510 can retrieve the EPG metadata from storage device 530, and display, using the EPG metadata the poster, program details, other information, etc. via display 210.

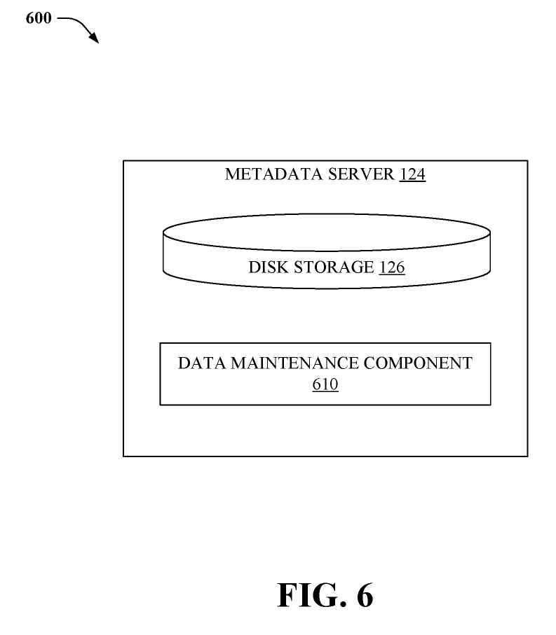

Now referring to FIG. 6, a metadata server including a data maintenance component (610) is illustrated, in accordance with various example embodiments. Data maintenance component 610 can be configured to determine, e.g., based on a defined period of time, e.g., every 7 days, whether respective portions of EPG metadata that have been stored in disk storage 126 and in data store 110, e.g., a movie data store, an Internet Movie Database (IMDb), etc. of cloud based digital TV service 105 are different. In this regard, in response to determining that the respective portions of the EPG metadata are different, metadata server 124 can copy a remote portion of the respective portions from data store 110 to a local portion of the respective portions on disk storage 126.

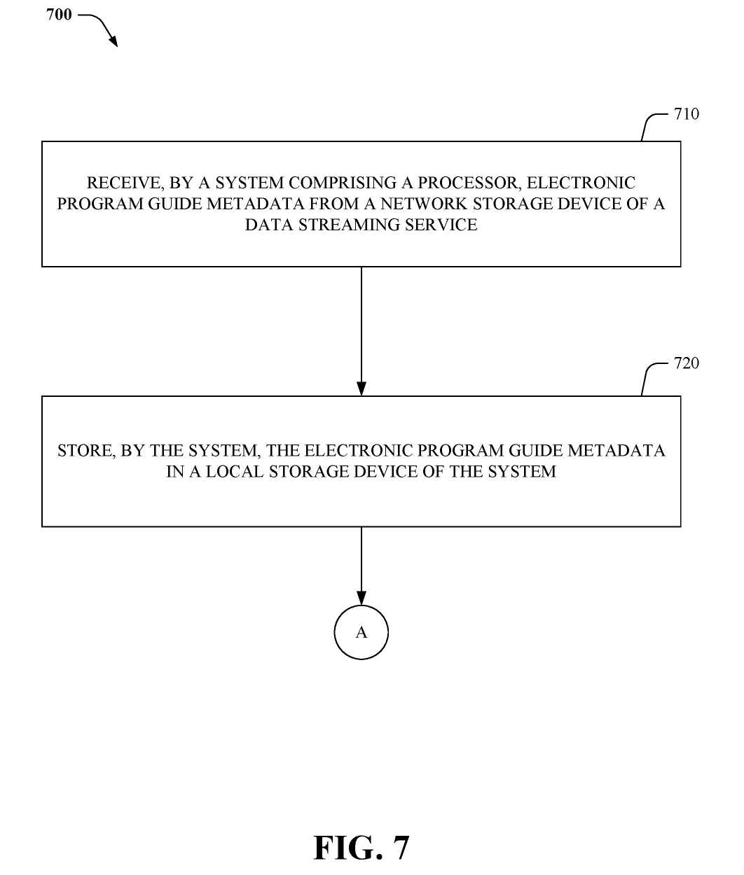

FIGS. 7-11 illustrate methodologies in accordance with the disclosed subject matter. For simplicity of explanation, the methodologies are depicted and described as a series of acts. It is to be understood and appreciated that the subject innovation is not limited by the acts illustrated and/or by the order of acts. For example, acts can occur in various orders and/or concurrently, and with other acts not presented or described herein. Furthermore, not all illustrated acts may be required to implement the methodologies in accordance with the disclosed subject matter. In addition, those skilled in the art will understand and appreciate that the methodologies could alternatively be represented as a series of interrelated states via a state diagram or events. Additionally, it should be further appreciated that some of the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

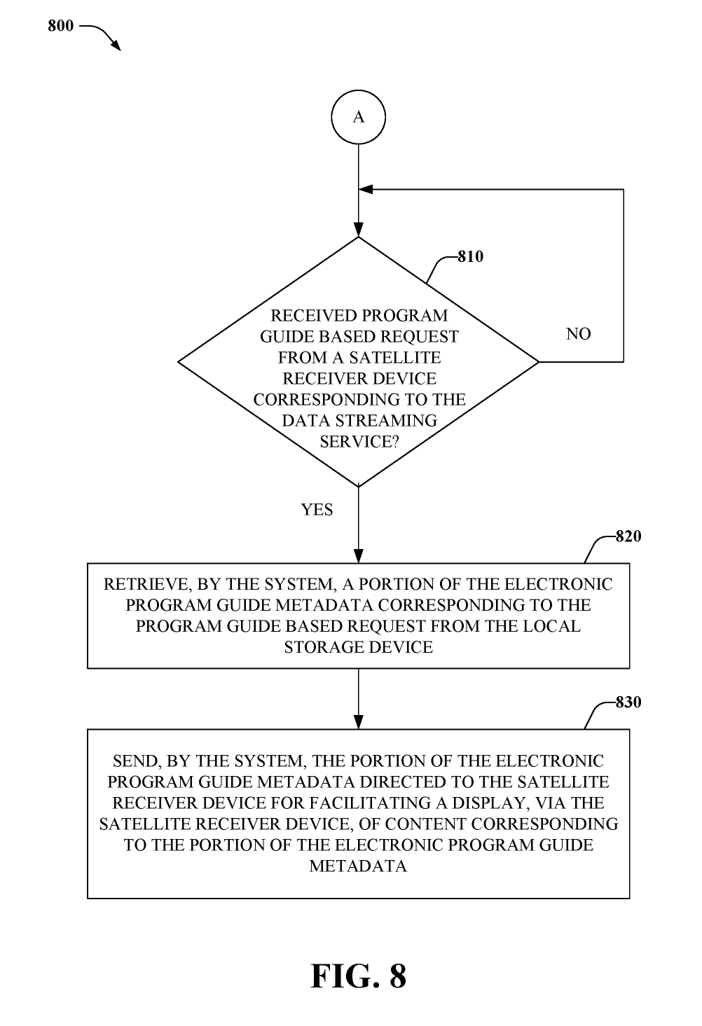

Referring now to FIGS. 7-8, processes (700, 800) performed by a metadata server (124) are illustrated, in accordance with various example embodiments. At 710, EPG metadata can be received from a network storage device of a network data streaming service. At 720, the electronic program guide metadata can be stored in a local storage device.

At 810, it can be determined whether a program guide based request has been received from a satellite receiver device corresponding to the data streaming service. In this regard, if it is determined that the program guide based request has been received, flow continues to 820; otherwise, flow returns to 810.

At 820, a portion of the electronic program guide metadata corresponding to the program guide based request can be retrieved from the local storage device. At 830, the portion of the electronic program guide metadata can be sent to the satellite receiver device for facilitating a display, via the satellite receiver device, of content corresponding to the portion of the electronic program guide metadata.

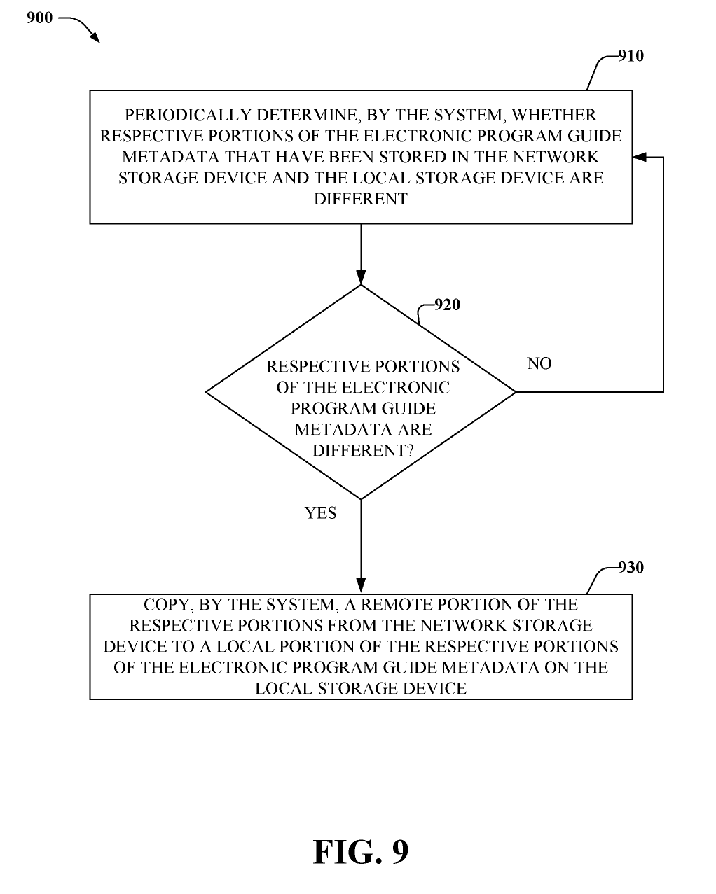

FIG. 9 illustrates a process (900) for updating electronic program guide metadata of a local storage device, in accordance with various example embodiments. At 910, it can be periodically determined, e.g., every 7 days, whether respective portions of the electronic program guide metadata that have been stored in the network storage device and the local storage device are different.

In response to determining, at 920, that the respective portions of the electronic program guide metadata are different, flow continues to 930, at which a remote portion of the respective portions can be copied from the network storage device to a local portion of the respective portions of the electronic program guide metadata on the local storage device; otherwise flow returns to 910.

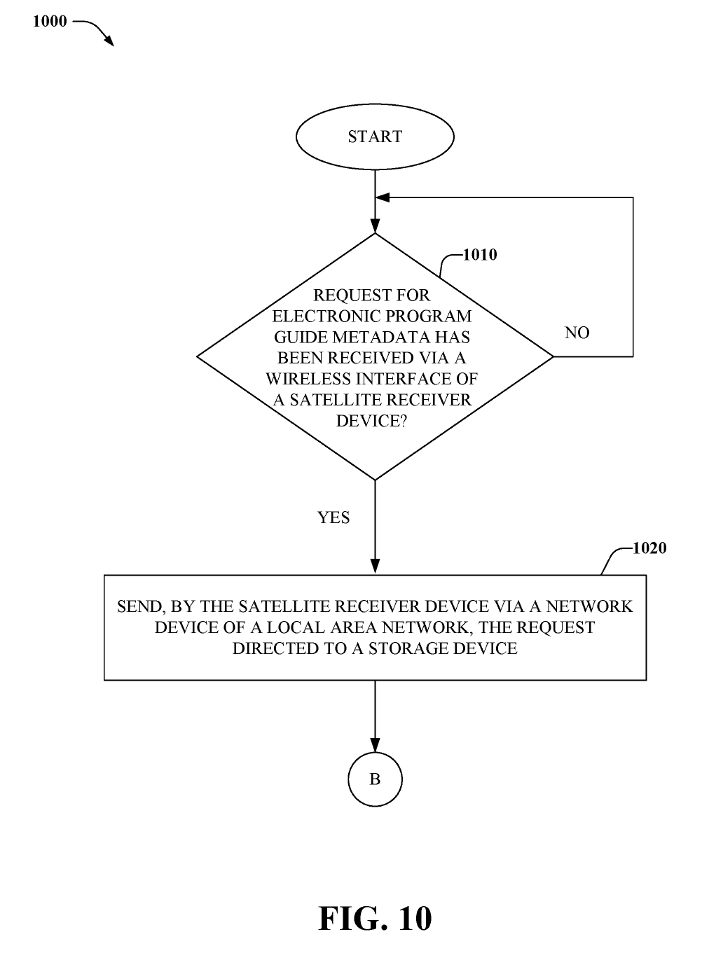

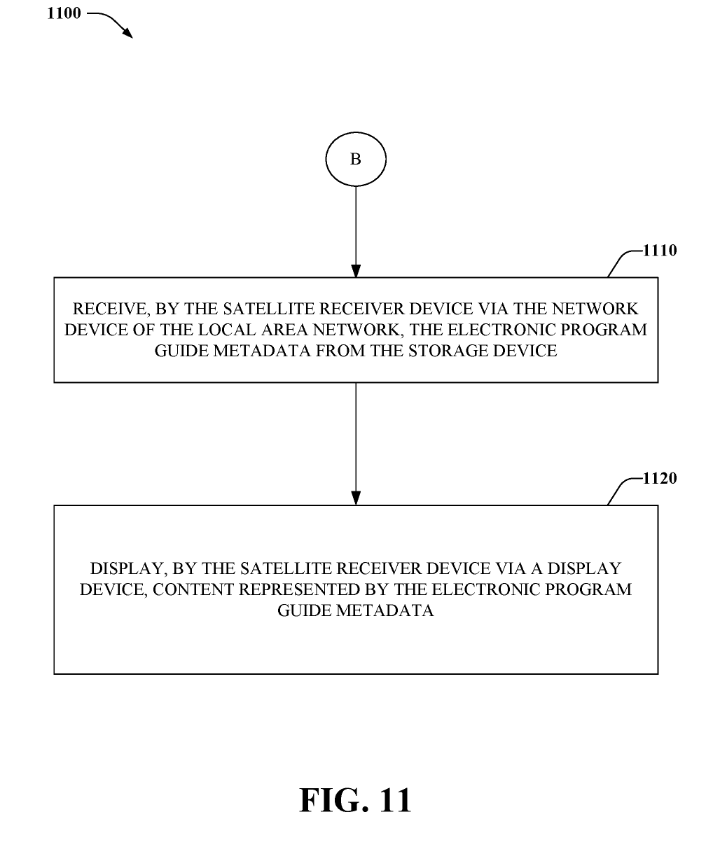

FIGS. 10-11 illustrate block diagrams (1000, 1100) of a process performed by a satellite receiver device, e.g., STB 150, in accordance with various example embodiments. At 1010, it can be determined whether a request for electronic program guide metadata has been received via a wireless interface of the satellite receiver device.

In response to determining that the request has been received, flow continues to 1020, at which the request can be sent by the satellite receiver device to a storage device via a network device of a LAN; otherwise flow returns to 1010.

Flow continues from 1020 to 1110, at which the electronic program guide metadata can be received, by the satellite receiver device via the network device of the LAN, from the storage device. At 1120, the satellite receiver device can display, via a display device, content e.g., a poster, program details, other information, etc. represented by the electronic program guide metadata.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions and/or processes described herein. Processors can exploit nano-scale architectures such as, but not limited to, molecular and quantum-dot based transistors, switches and gates, in order to optimize space usage or enhance performance of mobile devices. A processor may also be implemented as a combination of computing processing units.

In the subject specification, terms such as “disk storage,” “data store,” “storage device,” “data storage,” “database,” and substantially any other information storage component relevant to operation and functionality of a component and/or process, refer to “memory components,” or entities embodied in a “memory,” or components comprising the memory. It will be appreciated that the memory components described herein can be either volatile memory or nonvolatile memory, or can include both volatile and nonvolatile memory.

By way of illustration, and not limitation, nonvolatile memory, for example, can be included in data store 110, disk storage 126, memory 520, storage device 530, non-volatile memory 1222 (see below), disk storage 1224 (see below), and/or memory storage 1246 (see below). Further, nonvolatile memory can be included in read only memory (ROM), programmable ROM (PROM), electrically programmable ROM (EPROM), electrically erasable ROM (EEPROM), or flash memory. Volatile memory 1220 can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

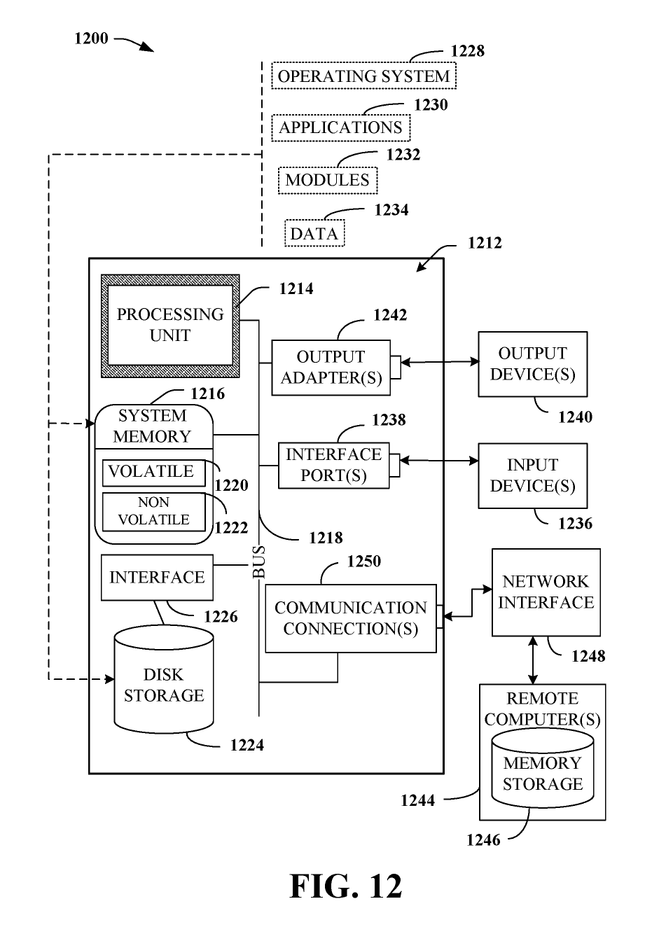

In order to provide a context for the various aspects of the disclosed subject matter, FIG. 12, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the subject innovation also can be implemented in combination with other program modules. Generally, program modules include routines, programs, components, data structures, etc. that perform particular tasks and/or implement particular abstract data types.

Moreover, those skilled in the art will appreciate that the inventive systems can be practiced with other computer system configurations, including single-processor or multiprocessor computer systems, mini-computing devices, mainframe computers, as well as personal computers, hand-held computing devices (e.g., PDA, phone, watch), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

With reference to FIG. 12, a block diagram of a computing system 1200 operable to execute the disclosed components, systems, devices, etc., e.g., small cell access point device 110, calibration component 140, polling component (210, 320), neighbor cell component (230, 340), public safety answering point component 150, etc. is illustrated, in accordance with an embodiment. Computer 1212 includes a processing unit 1214, a system memory 1216, and a system bus 1218. System bus 1218 couples system components including, but not limited to, system memory 1216 to processing unit 1214. Processing unit 1214 can be any of various available processors. Dual microprocessors and other multiprocessor architectures also can be employed as processing unit 1314.

System bus 1218 can be any of several types of bus structure(s) including a memory bus or a memory controller, a peripheral bus or an external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), Small Computer Systems Interface (SCSI), and/or controller area network (CAN) bus used in vehicles.

System memory 1216 includes volatile memory 1220 and nonvolatile memory 1222. A basic input/output system (BIOS), containing routines to transfer information between elements within computer 1212, such as during start-up, can be stored in nonvolatile memory 1222. By way of illustration, and not limitation, nonvolatile memory 1222 can include ROM, PROM, EPROM, EEPROM, or flash memory. Volatile memory 1220 includes RAM, which acts as external cache memory. By way of illustration and not limitation, RAM is available in many forms such as SRAM, dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

Computer 1212 also includes removable/non-removable, volatile/non-volatile computer storage media. FIG. 12 illustrates, for example, disk storage 1224. Disk storage 1224 includes, but is not limited to, devices like a magnetic disk drive, floppy disk drive, tape drive, Jaz drive, Zip drive, LS-100 drive, flash memory card, or memory stick. In addition, disk storage 1224 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1224 to system bus 1218, a removable or non-removable interface is typically used, such as interface 1226.

It is to be appreciated that FIG. 12 describes software that acts as an intermediary between users and computer resources described in suitable operating environment 1200. Such software includes an operating system 1228. Operating system 1228, which can be stored on disk storage 1224, acts to control and allocate resources of computer system 1212. System applications 1230 take advantage of the management of resources by operating system 1228 through program modules 1232 and program data 1234 stored either in system memory 1216 or on disk storage 1224. It is to be appreciated that the disclosed subject matter can be implemented with various operating systems or combinations of operating systems.

A user can enter commands or information into computer 1212 through input device(s) 1236. Input devices 1236 include, but are not limited to, a pointing device such as a mouse, trackball, stylus, touch pad, keyboard, microphone, joystick, game pad, satellite dish, scanner, TV tuner card, digital camera, digital video camera, web camera, cellular phone, user equipment, smartphone, and the like. These and other input devices connect to processing unit 1214 through system bus 1218 via interface port(s) 1238. Interface port(s) 1238 include, for example, a serial port, a parallel port, a game port, a universal serial bus (USB), a wireless based port, e.g., WiFi, Bluetooth®, etc. Output device(s) 1240 use some of the same type of ports as input device(s) 1236.

Thus, for example, a USB port can be used to provide input to computer 1212 and to output information from computer 1212 to an output device 1240. Output adapter 1242 is provided to illustrate that there are some output devices 1240, like display devices, light projection devices, monitors, speakers, and printers, among other output devices 1240, which use special adapters. Output adapters 1242 include, by way of illustration and not limitation, video and sound devices, cards, etc. that provide means of connection between output device 1240 and system bus 1218. It should be noted that other devices and/or systems of devices provide both input and output capabilities such as remote computer(s) 1244.

Computer 1212 can operate in a networked environment using logical connections to one or more remote computers, such as remote computer(s) 1244. Remote computer(s) 1244 can be a personal computer, a server, a router, a network PC, a workstation, a microprocessor based appliance, a peer device, or other common network node and the like, and typically includes many or all of the elements described relative to computer 1212.

For purposes of brevity, only a memory storage device 1246 is illustrated with remote computer(s) 1244. Remote computer(s) 1244 is logically connected to computer 1212 through a network interface 1248 and then physically and/or wirelessly connected via communication connection 1250. Network interface 1248 encompasses wire and/or wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1250 refer(s) to hardware/software employed to connect network interface 1248 to bus 1218. While communication connection 1250 is shown for illustrative clarity inside computer 1212, it can also be external to computer 1212. The hardware/software for connection to network interface 1248 can include, for example, internal and external technologies such as modems, including regular telephone grade modems, cable modems and DSL modems, wireless modems, ISDN adapters, and Ethernet cards.

The computer 1212 can operate in a networked environment using logical connections via wired and/or wireless communications to one or more remote computers, cellular based devices, user equipment, smartphones, or other computing devices, such as workstations, server computers, routers, personal computers, portable computers, microprocessor-based entertainment appliances, peer devices or other common network nodes, etc. The computer 1212 can connect to other devices/networks by way of antenna, port, network interface adaptor, wireless access point, modem, and/or the like.

The computer 1212 is operable to communicate with any wireless devices or entities operatively disposed in wireless communication, e.g., a printer, scanner, desktop and/or portable computer, portable data assistant, communications satellite, user equipment, cellular base device, smartphone, any piece of equipment or location associated with a wirelessly detectable tag (e.g., scanner, a kiosk, news stand, restroom), and telephone. This includes at least WiFi and Bluetooth® wireless technologies. Thus, the communication can be a predefined structure as with a conventional network or simply an ad hoc communication between at least two devices.

WiFi allows connection to the Internet from a desired location (e.g., a vehicle, couch at home, a bed in a hotel room, or a conference room at work, etc.) without wires. WiFi is a wireless technology similar to that used in a cell phone that enables such devices, e.g., mobile phones, computers, etc., to send and receive data indoors and out, anywhere within the range of a base station. WiFi networks use radio technologies called IEEE 802.11 (a, b, g, etc.) to provide secure, reliable, fast wireless connectivity. A WiFi network can be used to connect communication devices (e.g., mobile phones, computers, etc.) to each other, to the Internet, and to wired networks (which use IEEE 802.3 or Ethernet). WiFi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

Further, to the extent that the terms “includes,” “has,” “contains,” and other similar words are used in either the detailed description or the appended claims, such terms are intended to be inclusive—in a manner similar to the term “comprising” as an open transition word—without precluding any additional or other elements. Moreover, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Furthermore, the word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art.

As utilized herein, terms “server”, “service”, “component,” “system,” “interface,” and the like are intended to refer to a computer-related entity, hardware, software (e.g., in execution), and/or firmware. For example, a component can be a processor, a process running on a processor, an object, an executable, a program, a storage device, and/or a computer. By way of illustration, an application running on a server and the server can be a component. One or more components can reside within a process, and a component can be localized on one computer and/or distributed between two or more computers.

Further, components can execute from various computer readable media having various data structures stored thereon. The components can communicate via local and/or remote processes such as in accordance with a signal having one or more data packets (e.g., data from one component interacting with another component in a local system, distributed system, and/or across a network, e.g., the Internet, with other systems via the signal).

As another example, a component can be an apparatus with specific functionality provided by mechanical parts operated by electric or electronic circuitry; the electric or electronic circuitry can be operated by a software application or a firmware application executed by one or more processors; the one or more processors can be internal or external to the apparatus and can execute at least a part of the software or firmware application. As yet another example, a component can be an apparatus that provides specific functionality through electronic components without mechanical parts; the electronic components can include one or more processors therein to execute software and/or firmware that confer(s), at least in part, the functionality of the electronic components.

Aspects of systems, apparatus, and processes explained herein can constitute machine-executable instructions embodied within a machine, e.g., embodied in a computer readable medium (or media) associated with the machine. Such instructions, when executed by the machine, can cause the machine to perform the operations described. Additionally, the systems, processes, process blocks, etc. can be embodied within hardware, such as an application specific integrated circuit (ASIC) or the like. Moreover, the order in which some or all of the process blocks appear in each process should not be deemed limiting. Rather, it should be understood by a person of ordinary skill in the art having the benefit of the instant disclosure that some of the process blocks can be executed in a variety of orders not illustrated.

The disclosed subject matter can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, computer-readable carrier, or computer-readable media. For example, computer-readable media can include, but are not limited to, magnetic storage devices, e.g., hard disk; floppy disk; magnetic strip(s); optical disk (e.g., compact disk (CD), digital video disc (DVD), Blu-ray Disc (BD)); smart card(s); and flash memory device(s) (e.g., card, stick, key drive); and/or a virtual device that emulates a storage device and/or any of the above computer-readable media.

Artificial intelligence based systems, e.g., utilizing explicitly and/or implicitly trained classifiers, can be employed in connection with performing inference and/or probabilistic determinations and/or statistical-based determinations as in accordance with one or more aspects of the disclosed subject matter as described herein. For example, an artificial intelligence system can be used, via metadata server 124, to determine whether respective portions of EPG metadata that have been stored in a network storage device and a local storage device are different.

A classifier can be a function that maps an input attribute vector, x=(x1, x2, x3, x4, xn), to a confidence that the input belongs to a class, that is, f(x)=confidence (class). Such classification can employ a probabilistic and/or statistical-based analysis (e.g., factoring into the analysis utilities and costs) to infer an action that a user desires to be automatically performed. In the case of communication systems, for example, attributes can be information received from access points, servers, components of a wireless communication network, etc., and the classes can be categories or areas of interest (e.g., levels of priorities). A support vector machine is an example of a classifier that can be employed. The support vector machine operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein can also be inclusive of statistical regression that is utilized to develop models of priority.

In accordance with various aspects of the subject specification, artificial intelligence based systems, components, etc. can employ classifiers that are explicitly trained, e.g., via a generic training data, etc. as well as implicitly trained, e.g., via observing characteristics of event notifications reported by a file system, e.g., corresponding to checksum error(s), receiving operator preferences, receiving historical information, receiving extrinsic information, etc. For example, support vector machines can be configured via a learning or training phase within a classifier constructor and feature selection module. Thus, the classifier(s) can be used by an artificial intelligence system to automatically learn and perform a number of functions, e.g., performed by data recovery agent 110, data recovery search service 120, etc.

As used herein, the term “infer” or “inference” refers generally to the process of reasoning about, or inferring states of, the system, environment, user, and/or intent from a set of observations as captured via events and/or data. Captured data and events can include user data, device data, environment data, data from sensors, sensor data, application data, implicit data, explicit data, etc. Inference can be employed to identify a specific context or action, or can generate a probability distribution over states of interest based on a consideration of data and events, for example.

Inference can also refer to techniques employed for composing higher-level events from a set of events and/or data. Such inference results in the construction of new events or actions from a set of observed events and/or stored event data, whether the events are correlated in close temporal proximity, and whether the events and data come from one or several event and data sources. Various classification schemes and/or systems (e.g., support vector machines, neural networks, expert systems, Bayesian belief networks, fuzzy logic, and data fusion engines) can be employed in connection with performing automatic and/or inferred action in connection with the disclosed subject matter.

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

1. A method, comprising:
receiving, by a system comprising a processor via an Internet connection between the system and a network storage device of a data streaming service, electronic program guide metadata from the network storage device;
storing, by the system, the electronic program guide metadata in a local storage device of the system; and
in response to receiving, via a local area network based connection between the system and a satellite receiver device corresponding to the data streaming service, a program guide based request from the satellite receiver device,
retrieving, by the system via the local area network based connection, a portion of the electronic program guide metadata corresponding to the program guide based request from the local storage device, and
sending, by the system via the local area network based connection, the portion of the electronic program guide metadata directed to the satellite receiver device to facilitate a display, via the satellite receiver device, of content corresponding to the portion of the electronic program guide metadata.

2. The method of claim 1, wherein the electronic program guide metadata describes broadcast content of the data streaming service corresponding to a broadcast directed from a satellite wirelessly coupled to the satellite receiver device.

3. The method of claim 1, wherein the data streaming service comprises a direct-broadcast satellite television service.

4. The method of claim 1, wherein the electronic program guide metadata corresponds to movies of a movie data store accessible via the Internet connection.

5-7. (canceled)

8. The method of claim 1, further comprising:
determining, by the system, whether respective portions of the electronic program guide metadata that have been stored in the network storage device and the local storage device are different.

9. The method of claim 8, further comprising:
in response to determining that the respective portions of the electronic program guide metadata are different, copying, by the system, a remote portion of the respective portions from the network storage device to a local portion of the respective portions of the electronic program guide metadata on the local storage device.

10. A system, comprising:
a processor; and
a memory that stores executable instructions that, when executed by the processor, facilitate performance of operations, comprising:
obtaining, via an Internet based connection between the system and a network data store, metadata corresponding to a data streaming service from the network data store;
storing the metadata in a data storage device of the system; and
in response to receiving, via a local area network interface between the system and a satellite receiver device of the data streaming service, a request for a portion of the metadata from the satellite receiver device, sending, via the local area network interface, the portion of the metadata to the satellite receiver device to facilitate a display of content corresponding to the metadata.

11. (canceled)

12. The system of claim 10, wherein the metadata describes broadcast content of the data streaming service pending or being broadcast from a satellite to the satellite receiver device.

13. The system of claim 12, wherein the content comprises a direct-broadcast satellite television signal.

14-15. (canceled)

16. The system of claim 10, wherein the operations further comprise:
in response to determining that remotely stored metadata of the network data store has changed in the network data store, copying the remotely stored metadata from the network data store to the data storage device of the system.

17. A non-transitory machine-readable storage medium, comprising executable instructions that, when executed by a processor of a satellite receiver device, facilitate performance of operations, comprising:
in response to determining, via a wireless interface of the satellite receiver device, that a request for electronic program guide metadata has been received, sending, to a storage device by the satellite receiver device via a local area network interface between the satellite receiver device and the storage device, the request; and
in response to the sending of the request,
receiving, by the satellite receiver device via the local area network interface, the electronic program guide metadata from the storage device, and
displaying, by the satellite receiver device via a display device, content represented by the electronic program guide metadata.

18. The non-transitory machine-readable storage medium of claim 17, wherein the operations further comprise:
receiving, by the satellite receiver device, a data stream from a satellite corresponding to the content represented by the electronic program guide metadata.

19. The non-transitory machine-readable storage medium of claim 17, wherein the receiving further comprises:
receiving the electronic program guide metadata from the storage device, and wherein the storage device obtained, via the Internet, the electronic program guide metadata from a cloud based storage device corresponding to a data streaming service.

20. The non-transitory machine-readable storage medium of claim 19, wherein the data streaming service comprises a direct-broadcast satellite television service.

21. The method of claim 1, wherein the content comprises a rating.

22. The method of claim 1, wherein the content comprises at least a portion of a biography of an actor.

23. The method of claim 1, wherein the content comprises a description of at least one of a sequel or a prequel of a movie.

24. The non-transitory machine-readable storage medium of claim 17, wherein the operations further comprise:
storing, by the satellite receiver device, the electronic program guide metadata in a local storage device.

25. The non-transitory machine-readable storage medium of claim 24, wherein the displaying comprises:
in response to retrieving, by the satellite receiver device, the electronic program guide metadata from the local storage device, displaying the content.

26. The non-transitory machine-readable storage medium of claim 17, wherein the request for the electronic program guide metadata comprises a request for a poster comprising an image representing a data stream and program information describing content of the data stream.
